(19) United States
(12) Patent Application Publication
(10) Pub. No.: US 2009/0275401 A1
(43) Pub. Date: Nov. 5, 2009

(54) METHOD, SYSTEM, APPARATUS, AND ARTICLE OF MANUFACTURE FOR PROFILE-DRIVEN CONFIGURATION FOR ELECTRONIC GAMING MACHINES (EGMS)

(75) Inventors: Jeffrey L. Allen, Pleasanton, CA (US); Christopher P. Arbogast, Reno, NV (US); Bruce C. Rowe, Henderson, NV (US)

Correspondence Address: SEED INTELLECTUAL PROPERTY LAW GROUP, PLLC, 701 FIFTH AVENUE, SUITE 5400, SEATTLE, WA, 98104, US

(73) Assignee: BALLY GAMING, INC., Las Vegas, NV (US)

(21) Appl. No.: 12/112,473

(22) Filed: Apr. 30, 2008

(51) Int. Cl. A63F 9/24; G06F 17/00

(52) U.S. Cl. 463/29; 463/43; 463/37; 463/42

(57) ABSTRACT

Changes to configuration settings of disparate electronic gaming machines (EGMs) are indicated in a profile. The profile provides generalized values for the configuration settings and can provide a time schedule in which the changes are to be performed. The generalized values of the configuration settings are translated into specific values for particular EGMs. The EGMs may be interrogated to obtain current specific values of their configuration settings. The current specific values of the configuration settings are changed to the specific values translated from the generalized values provided in the profile.

### TECHNICAL FIELD

The present disclosure generally relates to electronic gaming machines (EGMs), and more particularly but not exclusively relates to configuration of electronic gaming machines.

### BACKGROUND INFORMATION

Various networked gaming systems have been developed over the years beginning at least in the 1980s. With acceptance and utilization, users such as casino operators have found it desirable to increase the computer management of their facilities and expand features available on networked gaming systems. For instance, various settings of gaming machines can be configured and reconfigured electronically. However, such as configuration/reconfiguration of gaming machines can be very labor intensive.

### BRIEF SUMMARY

One aspect provides a method to configure a plurality of electronic gaming machines (EGMs), each of the EGMs having at least one configuration parameter that is scaled differently than the at least one configuration parameter of other ones of the EGMs, the method including: receiving a profile having a generalized value of the at least one configuration parameter, the profile specifying a time schedule in which the EGMs are to be configured to implement the generalized value of the at least one configuration parameter; translating the generalized value of the at least one configuration parameter to a corresponding specific value of the at least one configuration parameter for each of the EGMs; obtaining from each of the EGMs a current specific value of respective the at least one configuration parameter; and changing the current specific value to the corresponding specific value for each of the EGMs according to the time schedule specified in the profile.

Another aspect provides an article of manufacture that includes a computer-readable medium having computer-readable instructions stored thereon that are executable by a processor to configure a plurality of electronic gaming machines (EGMs), each of the EGMs having at least one configuration parameter that is scaled differently than the at least one configuration parameter of other ones of the EGMs, by: examining a profile having a generalized value of the at least one configuration parameter; translating the generalized value of the at least one configuration parameter to a corresponding specific value of the at least one configuration parameter for each of the EGMs; and generating a configuration change command to change a current specific value, of respective the at least one configuration parameter at each of the EGMs, to the corresponding specific value for each of the EGMs.

Yet another aspect provides an apparatus adapted to control configuration of a plurality of electronic gaming machines (EGMs), each of the EGMs having at least one configuration parameter that is scaled differently than the at least one configuration parameter of other ones of the EGMs, the apparatus including: a storage unit adapted to store a profile having a generalized value of the at least one configuration parameter; a processor coupled to the storage unit and adapted to translate the generalized value of the at least one configuration parameter to a corresponding specific value of the at least one configuration parameter for each of the EGMs; and a network interface coupled to the processor and adapted to communicate with the EGMs to provide a configuration change command, generated by the processor, to the EGMs to change a current specific value of the at least one configuration parameter at the EGMs to the corresponding specific value.

Still another aspect provides a system that includes: a plurality of electronic gaming machine (EGM) means, each of the EGM means having at least one configuration parameter that is scaled differently than the at least one configuration parameter of other ones of the EGM means; input means for receiving a profile having a first value of the at least one configuration parameter, the profile specifying a time schedule in which the EGM means are to be configured to implement the first value of the at least one configuration parameter; translation means for translating the first value of the at least one configuration parameter to a corresponding second value of the at least one configuration parameter for each of the EGM means; communication means for obtaining from each of the EGM means a current second value of respective the at least one configuration parameter; and processor means for generating a configuration change command to change the current second value to the corresponding second value for each of the EGM means according to the time schedule specified in the profile.

A further aspect provides a configuration method for an electronic gaming machine (EGM) having at least one configuration parameter that is scaled differently than the at least one configuration parameter of at least one other EGM, the method including: receiving at the EGM a query for current configuration settings at the EGM; providing by the EGM the current configuration settings in response to the query; receiving at the EGM a configuration change command that instructs a configuration change from a current specific value, of at least one of the configuration settings, to a new specific value according to a time schedule; and performing the configuration change at the EGM, wherein the new specific value is obtained by translating a generalized value, applicable to all of the EGMs and as specified in a profile, of the at least one configuration setting to the new value.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram of a system according to one embodiment.

FIG. 2 is a block diagram showing elements of one embodiment of the system of FIG. 1 in more detail.

FIGS. 3-4 show graphical representations of example profile-driven configuration changes according to various embodiments.

FIGS. 5-6 are example lookup tables (LUTs) that provide translations between generalized values and specific values for configuration settings according to various embodiments.

FIG. 7 is a flowchart of a method to configure electronic gaming machines according to one embodiment.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

As an overview, one embodiment enables configuration setting changes (including content download) on a device, such as an electronic gaming machine (EGM), based on a pre-defined profile that may be time-based. For instance, EGM configuration setting changes (e.g., changes to configuration settings for currency denomination, reel speed, game volume, display brightness, bets-per-line, number of available lines, content download, etc.) can be pre-defined on a time-based schedule, referred to herein as a “profile.”

In an embodiment, a slot manager, casino operator, or other authorized user can use a tool to select the EGM having at least one configuration setting that is to be changed, select the configuration setting (including content) that should be changed, select the value(s) for the configuration setting(s) to be changed, and specify the time and date for the change(s). The EGM can then implement that profile-driven configuration change. A profile-driven configuration change of one embodiment includes an instruction set having a time schedule and one or more EGMs assigned to that time schedule, as well as the configuration settings.

As an illustration, a slot manager may want to eliminate all penny and nickel denominations from certain games every Friday night starting at 5:00 PM, and then restore the nickel denominations on Saturday morning starting at 9:00 AM but continue to eliminate all penny denominations. One embodiment enables the slot manager to create a time-based profile that implements the denomination change at 5:00 PM every Friday and at 9:00 AM on Saturday. This time-based profile may be created in advance for one or more EGMs, and then the profile itself and/or a configuration change command representing the profile is downloaded into the one or more EGMs and automatically set to run according to the schedule in the profile. Alternatively or additionally to downloading a profile or configuration change command into the EGMs and being set to run directly from the EGMs, one embodiment stores the profiles in a central location (such as at a server) and sends configuration change commands from the central location to the EGMs when the changes are due to cause the EGMs to change their configuration settings.

Various embodiments attempt to address an environment (such as in a casino or other gaming environment) wherein there may be a plurality of disparate EGMS, such as EGMs from different (or same) manufacturers that may have inconsistent or incompatible configuration settings. In such a situation, it may not be possible to set absolute (specific) values for configuration changes when each EGM does not implement a particular configuration change in the same way.

As a first consideration, if a reel speed on a slot machine is set to “high” so as to have a fast spin, that “high” setting may be completely different on a first manufacturer's slot machine as compared to a second manufacturer's slot machine. The first manufacturer's slot machine may have a scale of 1-5 for reel speed (with 1 being slow and 5 being fast), while the second manufacturer's has a different scale of 1-10 for reel speed (with 1 being slow and 10 being fast). Therefore, in order to enable changing of the reel speed to “high” for these two slot machines, one embodiment recognizes that a different configuration value for reel speed is needed for each of the two slot machines, rather than globally instructing them to both increase their speed to 5, for example, which is fast for one of the slot machines and medium speed for the other slot machine. Accordingly, one embodiment can instruct a change in reel speed to “fast” by translating “fast” to a specific value (e.g., 5 or 10 or other value corresponding to “fast”) for the slot machine that is being changed. In one embodiment, many of the profile-driven configuration changes can provide instructions to change to a low, medium, or high setting (instead of providing an absolute setting, like a change to volume 3), and then provide an instruction that translates from the low, medium, or high settings to the specific values that are recognized or otherwise compatible with the particular EGM.

As another consideration, there may be different EGMs from different manufacturers on the casino floor, with each EGM using a different scale or value range for some configurable settings, and the type of EGM or its settings may have further changed between the time a profile was initially created and when a change in configuration is due. Accordingly, one embodiment interrogates the EGMs for current configuration settings before configuration changes are to be made. By knowing how a particular EGM is currently configured, one embodiment is able to recognize whether the proposed configuration setting change(s) will be implemented correctly and can make adjustments in the profile if needed. One embodiment is thus able to provide and maintain a dynamic EGM “inventory” at the time that a configuration change is to occur.

One embodiment provides a lookup table or other suitable translation table or data structure for each game theme/manufacturer that correlates the low, medium, and high settings to a specific configuration setting value. Alternatively or additionally, translation of the operational characteristics may be performed.

For the reel speed example, the profile can instruct a value of low, medium, or high over a time period for one or more EGMs from a combination of different manufacturers and having a different setting value for low/medium/high reel speeds. When a profile-driven change is to be implemented, one embodiment interrogates each EGM (e.g., “What manufacturer and game theme are you?”). After determining the type of EGM and other current configuration settings, one embodiment refers to the lookup table or other data structure (which can be performed in real time) and obtains the specific reel speed value to send to the particular EGM to make a change to medium reel speed.

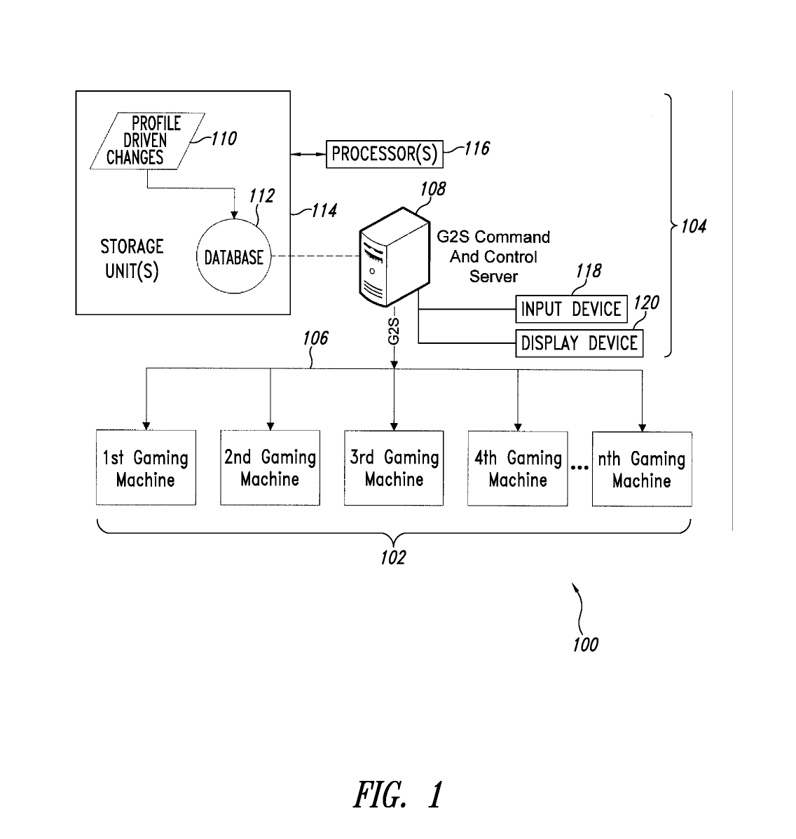

FIG. 1 shows a system 100 of according to one embodiment. The system 100 includes a plurality (1 to n) of electronic gaming machines (EGMs) 102. The EGMs 102 of one embodiment include disparate gaming machines, such as but not limited to: gaming machines that each play different games (e.g., slot machines, bingo, etc.), gaming machines made by different manufacturers, gaming machines that play the same game but are of different versions/models by the same manufacturer, or any other EGMs that may have similarities and differences as compared to other ones of the EGMs 102. Non-exhaustive and non-limiting examples of the EGMs 102 include slot machines, pachinko machines, video lottery terminals, video poker terminals, bingo machines, lotto machines, video keno terminals, video roulette terminals, video blackjack terminals, multi-game machines, and so forth. Moreover in one embodiment, machines or devices alternatively or additionally to the EGMs 102 can be provided with profile-driven configuration changes. Examples of such machines/devices can include, but not be limited to, iView displays, signage displays, kiosks, audio systems, and so forth.

According to one embodiment, the system 100 includes a command and control center 104 communicatively coupled to the EGMs 102 by a network 106. The network 106 can include wired and/or wireless communication links. Examples of the network 106 can include a local area network (LAN), virtual private network (VPN), an Internet connection, and/or any other network configuration that is capable to enable the command and control center 104 and the EGMs 102 to communicate with each other.

As will be described in further detail below, the command and control center 104 of one embodiment is adapted to interrogate the EGMs 102 for their current configuration settings and other information, and to download or otherwise cause such EGMs to run configuration setting changes. To perform such interrogation and configuration setting changes and other related operations, one embodiment of the command and control center 104 uses a game-to-system (G2S) command and control server 108 that is adapted to receive profile-driven configuration changes 110 (or more generally a “profile”) that includes the configuration settings to be implemented, and adapted to store the profile-driven configuration changes 110, configuration settings from interrogated EGMs 102, and/or other information in one or more databases 112 or other suitable data structure(s).

According to one embodiment, the command and control server 108 includes or is otherwise coupled to one or more storage units 114 adapted to store the database 112 and its information (including the profile-driven configuration changes 110). The command and control server 108 of one embodiment further includes one or more processors 116 adapted to perform at least some of the operations described herein with respect to interrogation of EGMs 102 and implementation of the profile-driven changes 110, an input device 118 to receive input information (including the profile-driven configuration changes 110) and commands from a user (such as a casino operator or network administrator), and a display device 120 to display a user interface or other information.

Examples of G2S components that can be used in one embodiment of the command and control server 108 to implement the features described herein are disclosed in U.S. patent application Ser. No. 11/938,225, entitled “PACKAGE MANAGER SERVICE IN GAMING SYSTEM,” filed Nov. 9, 2007, assigned to the same assignee as the present application, and incorporated herein by reference in its entirety.

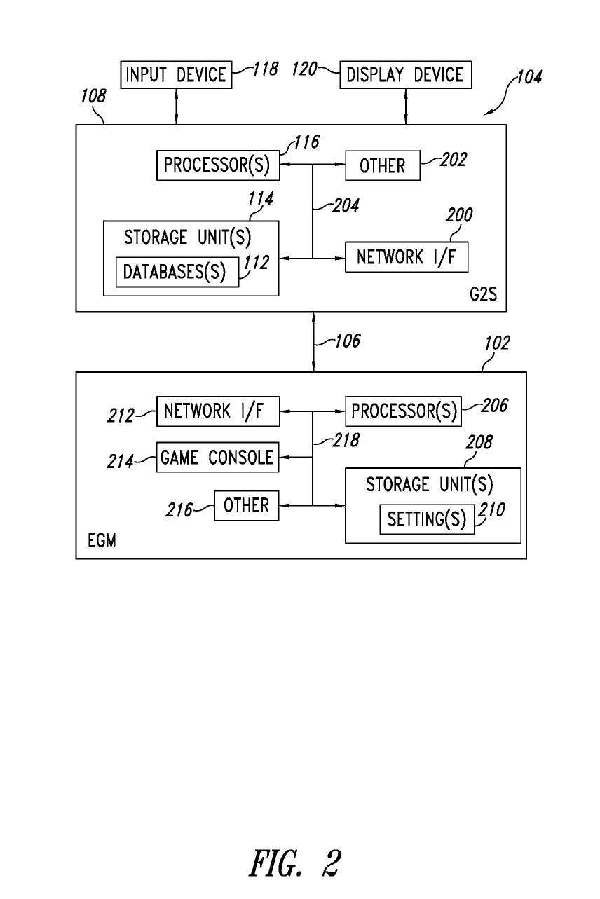

FIG. 2 shows embodiments of the command and control server 108 and one of the EGMs 102 in further detail. For the sake of brevity and simplicity of explanation, only certain elements of the command and control server 108 and the EGM 102, which are helpful in understanding the operation and features of the embodiments, are shown and described herein. Other elements are not shown or described herein, or just briefly described, again for the sake of simplicity of explanation.

Beginning first with the command and control server 108, one embodiment includes the processor(s) 116, the storage unit(s) 114, a network interface 200, and other elements 202 that are coupled together by a bus 204. The processor(s) 116 can be embodied for example as at least one microprocessor, controller, microcontroller, digital signal processor (DSP), and/or other processor. The storage unit(s) 114 can be embodied by a random access memory (RAM), a read only memory (ROM), or other hardware-based computer-readable storage medium.

In one embodiment, the storage unit(s) 114 have encoded or otherwise stored thereon computer-readable instructions that are executable by the processor(s) 116 to interrogate the EGMs 102, receive and process profile-driven configuration changes, provide the profile-driven configuration changes to the EGMs 102, and/or other various operations described herein. An example of the stored computer-readable instructions is a software program executable by the processor(s) 116.

As previously described with reference to FIG. 1, the storage unit(s) 114 can store one or more databases 112. The databases 112 of one embodiment can include at least one lookup table (LUT) adapted to store a translation between a specific value of a configuration setting of a particular EGM and a generalized value of the configuration setting. For example and as will be described in further detail below, a generalized value of “medium” audio volume level can be translated in the lookup table as a specific value of “5” audio volume level for a particular one of the EGMs 102. Alternatively or additionally to being stored in the databases 112, the LUT can be separate data structures stored in the storage unit(s) 114 in another embodiment.

The network interface 200 of one embodiment can include a transmitter/receiver (transceiver), modem, communication port(s)/antenna(s), and/or other communication elements to enable the command and control server 108 to communicate with the EGMs 102. The other elements 202 of the command and control server 108 can include a power supply, additional storage units or processors, software modules, and/or other electronic circuitry to support the operation of the command and control server 108.

The input device 118 of one embodiment is communicatively coupled to the command and control server 108, and enables the user to provide, modify, implement, override, etc. the profile-driven configuration changes 110. The input device 118 can also provide the user with various control capability over the other operations of the command and control server 108 and/or the EGMs 102. Examples of the input device 118 can include, but not be limited to, a keyboard, a mouse, touch-sensitive pad or screen (such as via fingertip or stylus control), and so forth.

The display device 120 of one embodiment is communicatively coupled to the command and control server 108, and provides a user interface that enables the user to view configuration settings that are to be provided to the EGMs 102 or that have been received from interrogated EGMs 102, as well as any other information related to the operation of the command and control server 108 and the EGMs 102. The display device 120 can be embodied for example as a display screen, and in one embodiment can itself provide the input device 118, such as if the input device 118 is a touch-sensitive screen.

One embodiment of the EGM 102 includes at least one processor 206, at least one storage unit 208 adapted to store one or more current configuration settings 210, a network interface 212, a game console 214, and other elements 216 that are coupled together by a bus 218. The processor(s) 206, the storage unit(s) 208, and the network interface 212 of one embodiment can be similar as those previously described above with respect to the command and control server 108, except that these elements are adapted to operate in an EGM. For example, the network interface 212 of one embodiment can include a transceiver, modem, communication port(s)/antenna(s), and/or other communication elements to enable the EGM 102 to communicate with the network interface 200 of the command and control server 108 via the network 106.

Further in one embodiment, the storage unit(s) 208 can have encoded or otherwise stored thereon computer-readable instructions that are executable by the processor(s) 206 to respond to interrogations from the command and control server 108, receive and implement/run profile-driven configuration changes, and/or other various operations described herein. An example of the stored computer-readable instructions is a software program executable by the processor(s) 206.

The game console 214 of one embodiment can include a user interface, visual and/or audible game indications, player controls, wager or other currency (including cash, tokens, chips, credit, coin, etc.) inputs and outputs, and/or other components related to playing a game on the EGM 102. The other elements 216 can include a random number generator, elements of the game console 214, additional processors or storage units, a power supply, electronic circuitry, software modules, and/or other elements of the EGM 102 related to operation thereof.

Examples of the current configuration settings 210 stored in the storage unit(s) 208 can include, but not be limited to: manufacturer information, cabinet type, EGM type (e.g., slot machine, video poker, bingo, etc.), EGM version number, volume setting (e.g., a numerical setting), game theme, minimum/maximum bet amount, currency denomination (e.g., $0.01, $0.05, etc.), reel speed (e.g., a numerical setting), bets per line, minimum bet per line, number of lines, minimum number of lines, start and/or end times for certain configuration settings, display brightness intensity, and/or other parameters. In one embodiment, any one or more of these and other configuration settings can be updated or upgraded, for instance if a new game version or enhancement is released by the manufacturer, such that such updates/upgrades may be provided to the EGMs 102 via the techniques for profile-driven configuration changes described herein.

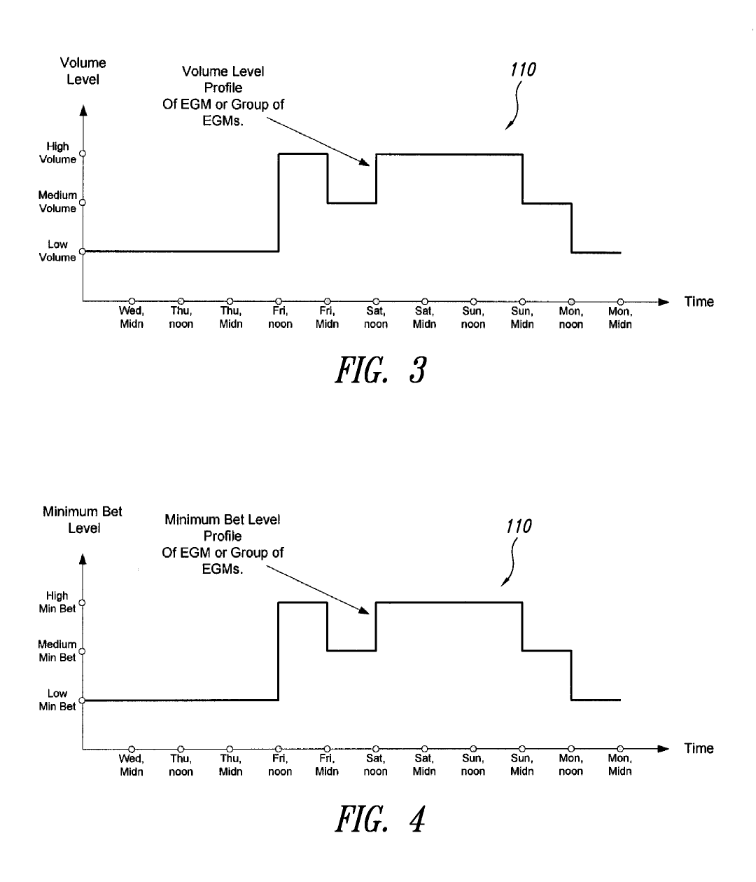

FIGS. 3-4 respectively show first and second examples of the profile-driven configuration changes 110. While the profile-driven configuration changes 110 shown in FIGS. 3-4 are represented in graphical form, such representations are merely provided to help in understanding operation of the embodiments. For instance, the profile-driven configuration changes 110 can be represented in tabular form or any other suitable time-based or non-time-based representation. Moreover, the examples shown in FIG. 3-4 are not intended to be limiting or exhaustive-other embodiments may implement different configuration setting values, time scales and time frames, configuration parameters, and so forth.

The example of FIG. 3 shows a volume versus time profile that can be assigned to one or more of the EGMs 102. The horizontal (time) axis represents a time schedule that is measured in terms of days of the week, while the vertical (volume) axis is measured in terms of generalized volume values (e.g., high, medium, and low volumes) over time. In this example, the volume level of the target EGM(s) 102 is set to “low” from before midnight on Wednesday up to noon on Friday; is set to “high” from noon on Friday up to midnight Friday; is set to “medium” from midnight Friday to noon Saturday; and so forth.

The example of FIG. 4 shows a minimum bet level versus time profile that can be assigned to one or more of the EGMs 102. The horizontal (time) axis represents a time schedule that is also measured in terms of days of the week, while the vertical (minimum bet level) axis is measured in terms of generalized bet level values (e.g., high, medium, and low minimum bets) over time. In this example, the minimum bet level of the target EGM(s) 102 is set to “low” from before midnight on Wednesday up to noon on Friday; is set to “high” from noon on Friday up to midnight Friday; is set to “medium” from midnight Friday to noon Saturday; and so forth.

In the depicted embodiments, the values on the vertical axis (e.g., volume, minimum bet, etc.) are generalized values of high, medium, and low. Other generalized values are possible, including, medium-low, very low, very high, medium-high, etc. Moreover for some profile-driven configuration changes 110 in other embodiments, the both generalized and absolute (specific) values can be provided in a profile.

In one embodiment, the profile-driven configuration changes 110 do not instruct the volume (or other EGM configuration parameter) to be set to a specific value (like “3”), but instead instructs the volume to be set to a generalized value (e.g., low, medium, or high level). This scaling is provided because each EGM 102 (and/or game theme or other features of an EGM 102) can have a different definition of a “low” or other volume level. For example, an EGM 102 of a first manufacturer might have a volume scale of 0-10, while an EGM 102 of a second manufacturer might have a different volume scale of 0-100. In such a situation, the command and control server 108 of one embodiment determines (for example via use of a lookup table) the specific volume to set a particular EGM 102, when instructed by the profile-driven configuration changes 110 to set the volume to “low” (or other generalized value), and can further perform such configuration change(s) in response to a current configuration setting (as obtained through interrogation) of the EGM 102 when the change is due to occur. The use of a lookup table and interrogation will be described later below.

As previously explained above, non-limiting and non-exhaustive examples of EGM parameters that can be configured using the generalized values in the profile-driven configuration changes 110, such as explained above, can include volume, reel speed, minimum bet, master volume, jackpot amount, and others. Non-limiting and non-exhaustive examples of EGM parameters that can be configured using absolute (specific) values in the profile-driven configuration changes 110 can include currency denomination, game themes, operating system, and others. For instance with currency denomination, the profile-driven configuration changes 110 can instruct the particular EGM 102 to convert to a specific currency denomination. In another embodiment, the profile-driven configuration changes 110 can provide generalized values for high/medium/low currency denominations, which are then translated by the command and control server 108 to specific currency denominations for the particular EGM(s) 102.

To provide a translation from the generalized values in the profile-driven configuration changes 110 to absolute (specific) values for the particular EGMs 102, one embodiment uses one or more lookup tables. As previously explained above, the lookup table(s) can be embodied in the database(s) 112 stored in the storage unit(s) 114 and/or may be separate data structures. While lookup tables are described herein for one or more embodiments, other embodiments may use translation techniques that are different. For example, one embodiment of the processor 116 of the command and control server 108 may dynamically perform a calculation of a specific value from the generalized value of a parameter, such as by interpolating between known maximum/minimum value limits for the particular EGM parameter.

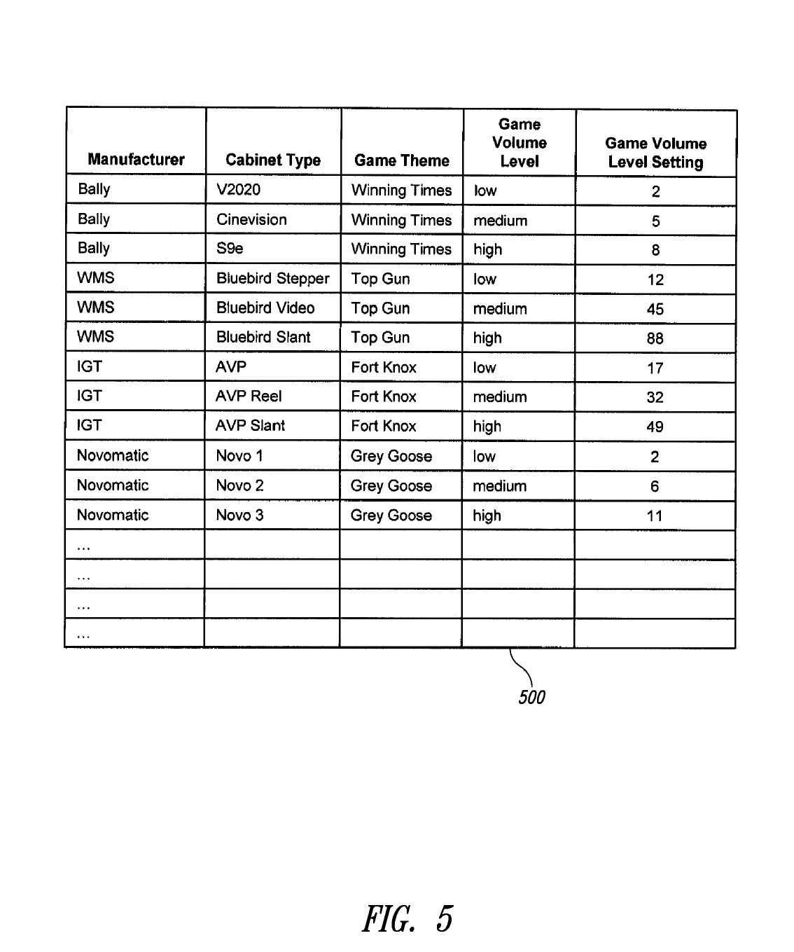

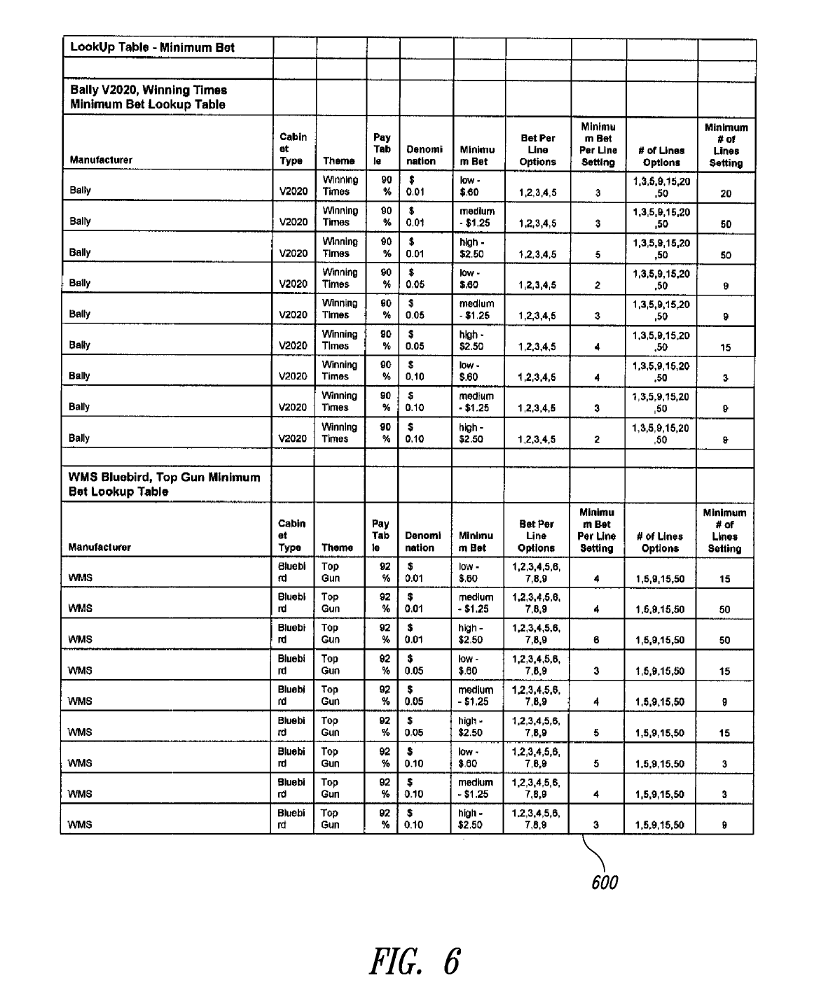

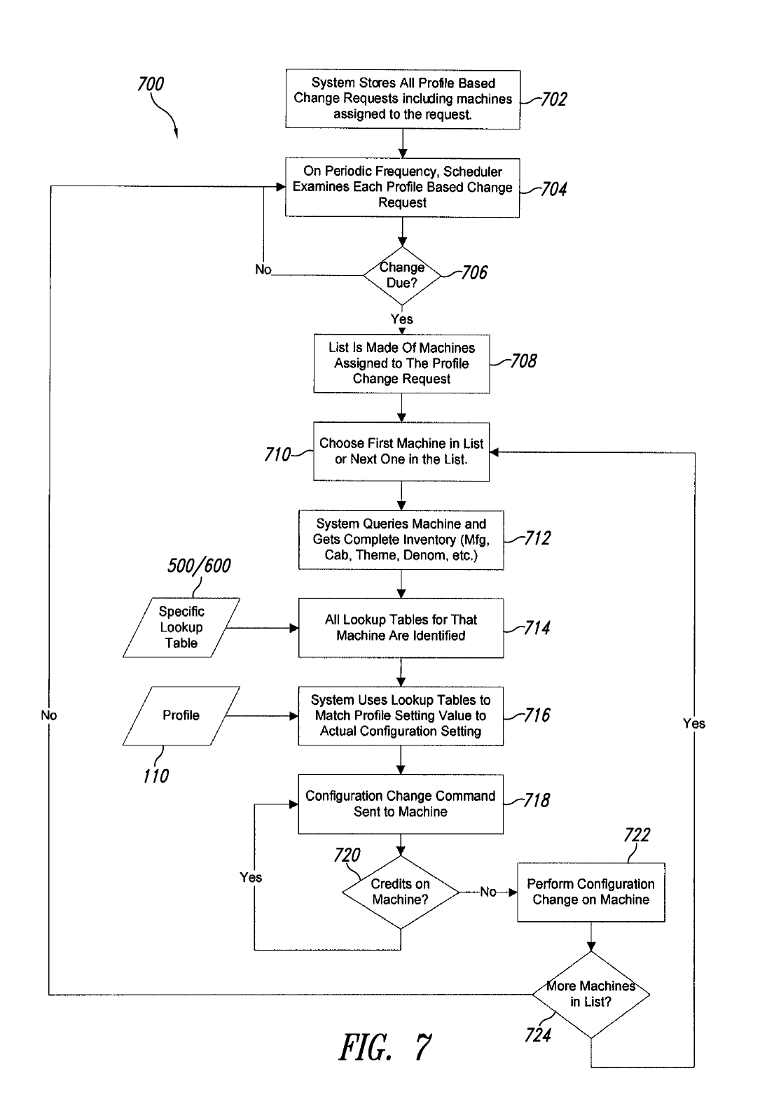

FIGS. 5-6 respectively show example lookup tables (LUTs) 500 and 600 that may be used by one embodiment of the processor 116 of the command and control server 108 to perform a translation of a generalized value to an absolute (specific) value when a profile-driven configuration change is to be performed. The specific information represented in the LUTs 500 and 600 are intended to be illustrative non-limiting and non-exhaustive examples. Other embodiments can provide other LUTs pertaining to other EGM parameters and related values.

The LUT 500 of FIG. 5 is usable for translation of volume values. When a volume change is dictated by the profile-driven configuration changes 110 for a particular one or more EGM 102, the command and control server 108 obtains the specific values of the particular EGM(s) 102 (such as via interrogation) and uses the LUT 500 to determine the specific volume setting value to use when switching to low, medium, or high volume.

As an illustration, the profile-driven configuration changes 110 might specify that particular EGMs 102 manufactured by WMS, having a “Bluebird Video” cabinet type, and with a “Top Gun” game theme should have a volume change to “medium” at noon on Friday. Based on this input information from the profile-driven configuration changes 110, the processor 116 of one embodiment accesses the LUT 500 and determines that the absolute (specific) volume value corresponding to “medium” is “45.” Accordingly, the command and control server 108 can directly change the volume setting of the particular EGM(s) 102 to “45” at noon on Friday, and/or can send instructions to the particular EGM(s) 102 to have them change their volume settings to “45” when Friday noon arrives.

As yet another illustration, the profile-driven configuration changes 110 might more generally specify all EGMs 102 change their volume setting to “high” at noon on Friday, without necessarily specifying the particular manufacturers' EGMs that are to be affected by the change. In such a situation, the command and control server 108 uses the LUT 500 to determine the specific volume values for “high” for each of the EGMs listed in the LUT 500, and then implements the volume change accordingly for each of the listed EGMs 102 for which a translation from “high” to a specific volume value is provided by the LUT 500.

Another example of a profile-driven change can be directed towards a minimum bet that is permitted for one or more EGMs 102. In such a situation, the casino operator may wish to control the minimum bet that a customer can make on a particular EGM 102 based on certain days and times. One embodiment controls the minimum bet on slot titles is by setting the number of lines on the game and the minimum coins to be bet per line.

The LUT 600 of FIG. 6 provides an example. In this example, the profile-driven configuration changes 110 might specify low, medium, and high generalized values. The processor 116 is adapted to use this input information from the profile-driven configuration changes 110 to access the LUT 600 and determine the settings (specific values) for minimum number of lines and for minimum bet per line for the affected EGMs 102.

In one embodiment, casino managers (or other users) and/or manufacturers can create these the LUTs at or prior to installation of the command and control center 104, and then only make changes to the LUTs if there are new settings or other updates that are desired. For example, the LUTs can be updated to add other manufacturers and their EGMs as such EGMs are connected to the command and control center 104. In one embodiment, the fields in the LUTs can be updated with information obtained from the EGMs 102, such as via interrogation.

According to one embodiment, the profile-driven configuration changes 110 or “profile” can be in the form of an input text file having certain specified settings for start time and dates/days, parameter values, etc., and that can be executed by the processor 116. The user can specify the various value settings in the text file of the profile. The following profile representation provides an example for changing the minimum bet value to “low” and “high” (generalized values) for the EGMs 102 at specific dates and times:

<!-- Showing use for minimum bet />

```
<ChangeProfile>
  <ChangeInstance StartTime=“Jan 30, 2007 6:00am”>
    <OptionItem name=“MinBetAmount”, value=“Low”>
  </ChangeInstance>
  <ChangeInstance StartTime=“Jan 30, 2007 4:00pm”>
    <OptionItem name=“MinBetAmount”, value=“High”>
  </ChangeInstance>
</ChangeProfile>
```

The following profile representation provides an example for changing the both the game speed and game volume values to certain specific values for the EGMs 102 at specific dates and times, although the generalized values (e.g., low, medium, and high) may be provided in a profile as well and then translated to specific values via the LUTs:

<!-- Showing use for game speed and game volume together* />

```
<ChangeProfile>
  <ChangeInstance StartTime=“Jan 30, 2007 6:00am”>
    <OptionItem name=“BAL_GameSpeed”, value=“1”>
    <OptionItem name=“BAL_GameVolume”, value=“5”>
  </ChangeInstance>
  <ChangeInstance StartTime=“Jan 30, 2007 4:00pm”>
    <OptionItem name=“BAL_GameSpeed”, value=“3”>
    <OptionItem name=“BAL_GameVolume”, value=“6”>
  </ChangeInstance>
</ChangeProfile>
```

In one embodiment, the profile can be provided in the form of extensible markup language (XML) file. An example profile representation using XML is provided below:

```
  <?xml version=“1.0” encoding=“utf-8” ?>
- <ChangeProfile name=“Sample MinBet Profile” author=“Haiyang”>
- <ChangeInstance startingTime=“2007-07-20 00:00:00”>
  <optionItem name=“MinBetAmount” value=“Low” />
    </ChangeInstance>
- <ChangeInstance startingTime=“2007-07-25 00:00:00”>
  <optionItem name=“MinBetAmount” value=“Medium” />
    </ChangeInstance>
- <ChangeInstance startingTime=“2007-07-29 00:00:00”>
  <optionItem name=“MinBetAmount” value=“High” />
    </ChangeInstance>
- <ChangeInstance startingTime=“2007-08-05 00:00:00”>
  <optionItem name=“MinBetAmount” value=“Medium” />
    </ChangeInstance>
- <ChangeInstance startingTime=“2007-08-29 00:00:00”>
  <optionItem name=“MinBetAmount” value=“High” />
    </ChangeInstance>
- <ChangeInstance startingTime=“2007-09-20 00:00:00”>
  <optionItem name=“MinBetAmount” value=“Low” />
    </ChangeInstance>
- ChangeInstance startingTime=“2007-10-21 21:00:00”>
  <optionItem name=“BAL_WaveVolume” value=“7” />
  <optionItem name=“BAL_LineVolume” value=“7” />
    </ChangeInstance>
- <ChangeInstance startingTime=“2007-11-21 21:00:00”>
  <optionItem name=“BAL_WaveVolume” value=“6” />
    </ChangeInstance>
- <ChangeInstance startingTime=“2007-12-22 21:00:00”>
  <optionItem name=“BAL_WaveVolume” value=“8” />
    </ChangeInstance>
    </ChangeProfile>
```

One embodiment of the command and control center 104 can use the XML data in the format above to not only implement the configuration changes in the EGMs 102, but also to build a visual representation of the profiles as shown in FIGS. 5-6 above for the benefit of the casino operator using the input device 118 and display deice 120 of the command and control center 104.

In one embodiment, when the processor 116 executes a profile, the processor 116 uses the LUT(s) to resolve the value of each parameter setting specified in the profile on a per-EGM basis. The LUT(s) may be made more generic so as to have columns/fields (and related information) for OptionName, OptionValue, G2S_DeviceClass, G2S_OptionGroup, G2S_Optionitem, and G2SOptionValue, alternatively or additionally to the example columns/fields shown in FIGS. 5-6.

When the command and control server 108 creates a job or other task to implement configuration changes based on the example profile representations above, the processor 116 can look up the OptionItem Name (specified in the profile) in the LUT for a given EGM's theme, pay table, volume, speed, denomination, and/or any other parameter. If one or more rows exist in the LUT that match the Optionitem Name's value specified in the profile, the processor 116 can map the Optionitem Name's value to a specific value for the EGM(s) 102 and generate and send the appropriate configuration change command to implement the specific value. As an example, MinBetAmount (value=“High”) from the profile is translated by the LUT into the respective specific values for Bal_MinBetPerLine and Bal_MinNumberOfLines. If no rows in the LUT match the information in the profile, one embodiment of the command and control server 108 can still send a configuration change command to implement the configuration change, if the value specified in the profile happens to match an actual parameter value for that EGM, such as BAL_GameSpeed for a game speed value. If there is still no match, the processor 116 can log an error.

In one embodiment, the fields of the LUT(S) can be adapted to contain “wildcard” characters (such as asterisks **) so as to reduce the number of rows/columns, and/or to potentially increase the frequency of matches. For instance, rather than having a separate LUT row for every each and every pay table, an embodiment can provide a wildcard character * under a paytable column in the LUT.

FIG. 7 is a flowchart of one embodiment of a method 700 to configure the EGMs 102. The various operations depicted in the flowchart need not necessarily be performed in the exact order shown. Moreover, some operations can be added, removed, modified, and/or combined.

In one embodiment, the operations represented by the method 700 can be implemented by computer-readable instructions encoded on or otherwise stored on a computer-readable medium and executable by a processor. For example, some operations of the method 700 can be implemented in software stored in the storage unit 114 of the command and control server 108, and executable by the processor 116. Corresponding operations of the method 700 that are related to the EGMs 102 can also be implemented in software or other computer-readable instructions stored in the storage unit 208 of the EGM 102, and executable by the processor 206.

At a block 702, the command and control center 104 receives via the input device 118 and stores in the storage unit(s) 112 profile-driven configuration changes 110 or other profile-based requests to change configuration settings that are input by the user. As previously explained above, the information specified in the profile-driven configuration changes 110 may include an identification of particular EGMs 102 that are assigned to the requests for configuration changes, as well as including generalized and/or specific values for configuration settings.

At a block 704, the processor 116 examines the stored profile(s) to determine whether a configuration change is due. In one embodiment, the processor 704 includes or is coupled to a scheduler that is adapted to examine the stored profile(s) according to a time schedule, such as a periodic frequency of hourly, every 12 hours, every 24 hours, or other timeframe configurable by the user. The scheduler repeatedly examines the stored profile(s) according to the time schedule, until a configuration change is determined to be due at a block 706.

If the configuration change is determined to be due at the block 706, the processor 116 at a block 708 generates a list of EGMs 102 that are to receive configuration changes. In one embodiment, the list of EGMs 102 can be generated from the EGMs specified in the profile.

At a block 710, the processor 116 chooses a first EGM 102 from the list. In one embodiment, the command and control server 108 then interrogates or otherwise queries that first EGM 102 at a block 712 for current specific values for its configuration settings 210 (e.g., manufacturer, cabinet, game theme, reel speed, current denomination, game volume, bet and line options, etc.). Obtaining the current specific values for configuration settings at the block 712, for each of the EGMs 102, enables the command and control server 108 to generate an updated inventory of the EGMs 102 and their current configuration settings. For instance, certain EGMs 102 may have been replaced/removed, or may have had their configuration settings modified between the time that the profile was created and when a configuration change specified in the profile is due. Interrogating the EGM(s) 102 with queries at the block 712 enables the processor 116 to determine whether the proposed configuration settings specified in the profile are still appropriate, and to make revisions if appropriate.

In one embodiment, the EGM(s) 102 can provide their current configuration settings at the block 712 independently of a query from the command and control server 108. For instance, rather than specifically interrogating the EGM(s) 102, whether via a global interrogation or selective individual interrogations, one embodiment can provide one or more EGMs 102 that report their current configuration settings to the command and control server 108 according to a time schedule and/or in response to some condition being met.

At a block 714, the processor 116 accesses or otherwise identifies one or more lookup tables (such as the LUTs 500 and 600 shown in FIGS. 5-6) that have entries for the EGM 102. At a block 716, the processor 116 uses the LUT(s) to match the information specified in the profile (e.g., the generalized values of the configuration settings indicated in the profile-driven configuration changes 110) to specific values of current configuration settings. With this use of the LUTs, the processor 116 is thus able to provide a translation from the generalized values to specific values for configuration settings.

At a block 718, the command and control server 108 generates a configuration change command and sends the generated command to the EGM 102. In one embodiment, the generated command instructs the target EGM 102 to change to the new configuration setting value upon receipt of the command. Thus, the command and control server 108 can send the generated command to the target EGM 102 just before the time frame when the change is to take effect, thereby directly controlling the timing of the change. In another embodiment, the command and control server 108 can send the generated command to the target EGM 102 at any suitable length of time (e.g., at a greater lead time) prior to the scheduled configuration change, so that the target EGM 102 can set itself to run or otherwise perform the configuration change when the change is due.

In some situations, the target EGM 102 may have credits that are due or otherwise currently engaged in a game with a player, when the configuration change command is received. Accordingly at a block 720 for one embodiment, the configuration change is not performed immediately. Rather, for example, the command and control server 108 can continue to send/re-send the configuration change command to the target EGM 102 if the target EGM 102 has credits that are due or is otherwise currently engaged in a game with a player, until the EGM 102 is ready to perform the configuration change at a block 722.

The operations described above in blocks 710-722 are repeated if the processor 116 determines at a block 724 that there are additional EGMs 102 in the generated list that are scheduled for configuration changes. When there are no such other EGMs 102 scheduled for configuration changes, then the method 700 reverts back to the block 704 to examine the stored profiles for upcoming configuration changes that are coming due.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method to configure a plurality of electronic gaming machines (EGMs), each of said EGMs having at least one configuration parameter that is scaled differently than said at least one configuration parameter of other ones of said EGMs, the method comprising:
receiving a profile having a generalized value of said at least one configuration parameter, said profile specifying a time schedule in which said EGMs are to be configured to implement said generalized value of said at least one configuration parameter;
translating said generalized value of said at least one configuration parameter to a corresponding specific value of said at least one configuration parameter for each of said EGMs;
obtaining from each of said EGMs a current specific value of respective said at least one configuration parameter; and
changing said current specific value to said corresponding specific value for each of said EGMs according to said time schedule specified in said profile.

2. The method of claim 1 wherein said obtaining includes interrogating each of said EGMs with a query for said current specific value of respective said at least one configuration parameter.

3. The method of claim 1 wherein said at least one configuration parameter that is scaled differently includes one or more of an audio volume, currency denomination, reel speed, display brightness, minimum bet, maximum bet, jackpot amount, bets-per-line, and number of available lines.

4. The method of claim 1 wherein said profile further includes an absolute value of at least one other configuration parameter, said profile further specifying in said time schedule when at least one of said EGMs is to be configured to implement said absolute value of said at least one other configuration parameter.

5. The method of claim 1 wherein said absolute value of said at least one other configuration parameter specifies one or more of a particular game theme, operating system, and denomination to be configured at said at least one EGM.

6. The method of claim 1 wherein said translating includes using a lookup table to determine said specific value that corresponds to said generalized value.

7. The method of claim 1 wherein said receiving said profile includes receiving an extensible markup language (XML) file that includes said profile.

8. The method of claim 1 wherein said changing said current specific value to said corresponding specific value includes providing a configuration change command to each of said EGMs to directly change said current specific value.

9. The method of claim 1 wherein said changing said current specific value to said corresponding specific value includes providing a configuration change command to each of said EGMs to set said EGMs to automatically run a configuration change at a time specified in said time schedule.

10. An article of manufacture, comprising:
a computer-readable medium having computer-readable instructions stored thereon that are executable by a processor to configure a plurality of electronic gaming machines (EGMs), each of said EGMs having at least one configuration parameter that is scaled differently than said at least one configuration parameter of other ones of said EGMs, by:
examining a profile having a generalized value of said at least one configuration parameter;
translating said generalized value of said at least one configuration parameter to a corresponding specific value of said at least one configuration parameter for each of said EGMs; and
generating a configuration change command to change a current specific value, of respective said at least one configuration parameter at each of said EGMs, to said corresponding specific value for each of said EGMs.

11. The article of manufacture of claim 10 wherein said computer-readable further includes computer-readable instructions stored thereon that are executable by said processor to configure said plurality of EGMs, by:
interrogating each of said EGMs to obtain therefrom said current specific value of respective said at least one configuration parameter.

12. The article of manufacture of claim 10 wherein said computer-readable further includes computer-readable instructions stored thereon that are executable by said processor to configure said plurality of EGMs, by:
interrogating each of said EGMs to obtain therefrom said current specific value of respective said at least one configuration parameter.

13. The article of manufacture of claim 10 wherein said profile specifies a time schedule in which said EGMs are to be configured to implement said generalized value of said at least one configuration parameter, and wherein said instructions executable by said processor to generate said configuration change command change include instructions executable by said processor to configure said plurality of EGMs, by:
specifying in said configuration change command a configuration change from said current specific value to said corresponding specific value for each of said EGMs according to a time schedule specified in said profile.

14. An apparatus adapted to control configuration of a plurality of electronic gaming machines (EGMs), each of said EGMs having at least one configuration parameter that is scaled differently than said at least one configuration parameter of other ones of said EGMs, the apparatus comprising:
a storage unit adapted to store a profile having a generalized value of said at least one configuration parameter;
a processor coupled to said storage unit and adapted to translate said generalized value of said at least one configuration parameter to a corresponding specific value of said at least one configuration parameter for each of said EGMs; and
a network interface coupled to said processor and adapted to communicate with said EGMs to provide a configuration change command, generated by said processor, to said EGMs to change a current specific value of said at least one configuration parameter at said EGMs to said corresponding specific value.

15. The apparatus of claim 14 wherein said profile specifies a time schedule in which said EGMs are to be configured to implement said generalized value of said at least one configuration parameter.

16. The apparatus of claim 15 wherein said configuration change command generated by said processor specifies a time schedule in which to perform said change of said current specific value to said corresponding specific value.

17. The apparatus of claim 14 wherein said processor in cooperation with said network interface is further adapted to obtain from each of said EGMs said current specific value of respective said at least one configuration parameter, via interrogation of said EGMs with a respective query sent from said network interface.

18. The apparatus of claim 14 wherein said storage unit is further adapted to store a data structure that provides a translation between said generalized value and said corresponding specific value of said at least one configuration parameter for each of said EGMs, and wherein said processor is adapted to access said data structure to obtain said translation.

19. The apparatus of claim 18 wherein said data structure includes a lookup table.

20. A system, comprising:
a plurality of electronic gaming machine (EGM) means, each of said EGM means having at least one configuration parameter that is scaled differently than said at least one configuration parameter of other ones of said EGM means;
input means for receiving a profile having a first value of said at least one configuration parameter, said profile specifying a time schedule in which said EGM means are to be configured to implement said first value of said at least one configuration parameter;
translation means for translating said first value of said at least one configuration parameter to a corresponding second value of said at least one configuration parameter for each of said EGM means;
communication means for obtaining from each of said EGM means a current second value of respective said at least one configuration parameter; and
processor means for generating a configuration change command to change said current second value to said corresponding second value for each of said EGM means according to said time schedule specified in said profile.

21. The system of claim 20 wherein said translation means includes a lookup table.

22. The system of claim 20 wherein said first value includes a generalized value of said at least one configuration parameter, and wherein said second value includes a specific value of said at least one configuration parameter.

23. The system of claim 20 wherein at least some of said EGM means are adapted to provide said respective current second value of said at least one configuration parameter to said communication means, independent of a query from said communication means.

24. The system of claim 20 wherein said communication means obtains said current second value of said at least one configuration parameter from respective said EGM means by interrogating said EGM means.

25. The system of claim 20 wherein said plurality of EGM means includes disparate ones of slot machines, pachinko machines, video lottery terminals, video poker terminals, video roulette terminals, video blackjack terminals, video keno terminals, bingo machines, lotto machines, and multi-game machines.

26. The system of claim 20 wherein said processor means sends said generated configuration change command to each of said EGM means to directly change said current second value.

27. The system of claim 20 wherein at least one of said plurality of EGM means receives said configuration change command generated by said processor means, and sets itself to run said configuration change command at a time specified by said time schedule to change said current second value to said corresponding second value.

28. A configuration method for an electronic gaming machine (EMG) having at least one configuration parameter that is scaled differently than said at least one configuration parameter of at least one other EGM, the method comprising:
receiving at said EGM a query for current configuration settings at said EGM;
providing by said EGM said current configuration settings in response to said query;
receiving at said EGM a configuration change command that instructs a configuration change from a current specific value, of at least one of said configuration settings, to a new specific value according to a time schedule; and
performing said configuration change at said EGM,
wherein said new specific value is obtained by translating a generalized value, applicable to all of said EGMs and as specified in a profile, of said at least one configuration setting to said new value.

29. The method of claim 28 wherein said performing said configuration change includes performing said configuration change in response to said receiving said configuration change command.

30. The method of claim 28 wherein said performing said configuration chance includes setting by said EGM said configuration change command to be run by said EGM a time specified by said time schedule when said configuration change is due.
